(19) United States
(12) Patent Application Publication
(10) Pub. No.: US 2015/0104237 A1
(43) Pub. Date: Apr. 16, 2015

(54) LOW-PROFILE RING BINDER MECHANISM

(71) Applicant: World Wide Stationery Mfg. Co., Ltd., Hong Kong (CN)

(72) Inventor: Chen Yuen To, Hong Kong (CN)

(21) Appl. No.: 14/334,312

(22) Filed: Jul. 17, 2014

(30) Foreign Application Priority Data
Oct. 15, 2013 (CN) 201310481957.8

(51) Int. Cl. B42F 13/22

(52) U.S. Cl. CPC B42F 13/22; B42P 2241/28
USPC 402/36

(57) ABSTRACT

A ring binder mechanism for retaining loose-leaf pages includes an elongate housing, a first and second hinge plate, at least one ring for holding the loose-leaf pages, and an actuator mounted on the housing. Each ring includes a first ring member and a second ring member. The first ring member is mounted on the first hinge plate for movement with the hinge plate relative to the housing between a closed position and an opened position. The first hinge plate has a first hinge member and the second hinge plate has a second hinge member. The hinge members are disposed at a distance from the mid-plane that is the same as or less than the greatest distance between the upper surface and the mid-plane. An actuator is mounted on the housing for pivotal movement relative to the housing for moving the rings from their closed position to their opened position.

### CROSS REFERENCE TO RELATED APPLICATIONS

This application claims priority to Chinese Application No. 201310481957.8 filed Oct. 15, 2013, the entire contents of which are hereby incorporated by reference.

### FIELD

The present invention is directed generally to a ring binder mechanism for retaining loose-leaf pages.

### BACKGROUND

Typical ring binder mechanisms have a plurality of rings for retaining loose-leaf pages, such as hole-punched pages, in a file or notebook. The rings can be selectively opened to add or remove pages from the ring binder mechanism or closed to retain the pages while allowing the pages to be moved along the rings. Each of the rings includes paired ring members mounted on adjacent hinge plates that are joined together at a hinge for pivoting movement about an axis. A housing, which is typically metal and elongate, supports the hinge plates within the housing for pivotal movement relative to the housing about the pivot axis. Often, the housing is generally arch-shaped (e.g., U-shaped or C-shaped) in cross-section, with bent-under rims that hold the hinge plates within the housing.

The housing of the ring binder mechanism typically has an exposed metal outer surface. This exposed surface often contains nickel plating, to which some people may be sensitive. Additionally, it is difficult and costly to print on a metal surface particularly where the metal surface is nickel-plated. The process of nickel plating can also present some environmental and work hazard issues. Accordingly, it is known in some instances to replace the metal housing with a housing constructed from a polymeric material.

The metallic or polymeric housing, in an undeformed state, is slightly narrower than the joined hinge plates when the hinge plates are in a coplanar position. As the hinge plates pivot through this coplanar position, they deform the resilient housing laterally outwardly and cause a spring force in the housing to urge the hinge plates to pivot away from the coplanar position, either upward to open the rings or downward to close the rings. When the rings are closed, the spring force of the housing resists hinge plate movement and thereby holds the rings together. Similarly, when the rings are opened, the spring force of the housing holds them apart. Typically, an operator can overcome the spring force of the housing by manually pulling the ring members of the rings apart or pushing them together.

In order for the rings to open as wide as possible for receiving or removing paper from the rings, the hinge plates to which the rings are attached need to pivot over a substantial distance. However, movement of the hinge plates toward an open position is limited by the underside of the housing. The problem may be exacerbated when polymeric hinge plates are employed that may need to be thicker than metal hinge plates. In the traditional design, the only way to allow the rings to open more fully is to increase the distance between the hinge plates and the bottom of the housing. One would previously only accomplish this task by increasing the height of the housing. However, a higher housing causes a bulkier ring binder mechanism that can interfere with turning pages along the rings in the notebook.

### SUMMARY

In one aspect, the present invention is directed to a ring binder mechanism for retaining loose-leaf pages generally including an elongate housing, first and second hinge plates supported by the housing for pivoting motion relative to the housing, and at least one ring for holding the loose-leaf pages. The first and second hinge plates each have an upper surface, a lower surface, and a mid-plane between the upper and lower surfaces. The ring holds the loose-leaf pages and includes a first ring member and a second ring member. The first ring member is mounted on the first hinge plate and moveable with the first hinge plate relative to the housing between a closed position and an open position. In the closed position, the first and second ring members cooperatively form a substantially continuous, closed loop for allowing loose-leaf pages retained by the rings to be moved along the rings from one ring member to the other. In the open position, the first and second ring members form a discontinuous, open loop for adding or removing loose-leaf pages from the rings. The first hinge plate includes a first hinge member, and the second hinge plate includes a second hinge member engaged with the first hinge member of the first hinge plate. The first and second hinge members having a maximum spacing from the mid-plane that is the same as or less than the greatest distance between the upper surface and the mid-plane away from the first or second hinge member.

In another aspect, the present intention is directed to a ring binder mechanism for retaining loose-leaf pages, the mechanism generally comprising an elongate housing, a first hinge plate and a second hinge plate, the hinge plates being supported by the housing for pivoting motion relative to the housing. The hinge plates have an inner longitudinal edge margins hingedly engaged with each other to permit the pivoting motion and an outer longitudinal edge margins engaged with the housing. At least one ring for holding the loose-leaf pages including a first ring member and a second ring member. The first ring member is mounted on the first hinge plate and moveable with the first hinge plate relative to the housing between a closed position and an open position. In the closed position, the first and second ring members cooperatively forming a substantially continuous, closed loop for allowing loose-leaf pages retained by the ring to be moved along the ring from one ring member to the other. In the open position the first and second ring members form a discontinuous, open loop for adding or removing loose-leaf pages from the ring. The outer longitudinal edge margins are each rounded to facilitate the pivoting motion of the first and second hinge plates with respect to the housing.

Other features will be in part apparent and in part pointed out hereinafter.

### BRIEF DESCRIPTION OF THE DRAWINGS

FIG. 1 is a perspective of a notebook including a ring binder mechanism;

FIG. 2 is a perspective of the ring binder mechanism;

FIG. 3 is an exploded perspective thereof;

FIG. 3A is a perspective of the bottom of a housing of the ring binder mechanism;

FIG. 3B is an enlarged fragmentary portion of the housing of FIG. 3A;

FIG. 4 is a front view of the ring binder mechanism;

FIG. 5 is a right end view thereof;

FIG. 6 is a top view thereof;

FIG. 7 is a bottom view thereof;

FIG. 8 is a section taken in plane including line 8-8 of FIG. 4 with hinge plates exploded directly below the housing;

FIG. 9 is a perspective of a hinge plate and associated ring members;

FIG. 10 is a cross section of the hinge plate and one of the associated ring members;

FIG. 11 is an enlarged section of the ring binder mechanism taken in the plane including line 11-11 of FIG. 2;

FIG. 12 is the enlarged section of FIG. 11 but with the ring binder mechanism in an open position;

FIG. 13 is a section taken in the plane including line 13-13 of FIG. 9;

FIG. 14 is a section taken in the plane including line 14-14 of FIG. 9;

FIG. 15 is a perspective of a cross section of the hinge plate taken through one of the associated ring members;

FIG. 16 is an enlarged, fragmentary cross section of the ring binder mechanism showing engagement of a rounded edge of the hinge plate engaging a housing of the ring binder mechanism in the closed position;

FIG. 17 is an enlarged fragmentary cross section of the ring binder mechanism showing engagement of the rounded edge of the hinge plate engaging the housing in an open position of the ring binder mechanism;

FIG. 18 is an enlarged fragmentary view of the hinge plates with the housing of the ring binder mechanism removed;

FIG. 19 is a perspective of a second embodiment of the ring binder mechanism;

FIG. 20 is a fragmentary longitudinal section thereof;

FIG. 21 is a perspective of a ring binder mechanism of a third embodiment;

FIG. 22 is a bottom view thereof;

FIG. 23 is a front view thereof;

FIG. 24 is an exploded view thereof;

FIG. 25 is an enlarged, fragmentary longitudinal section thereof;

FIG. 26 is an enlarged section taken in the plane including line 26-26 of FIG. 21 showing the ring binder mechanism in a closed and unlocked configuration;

FIG. 27 is the section of FIG. 26 but showing the ring binder mechanism in a closed and locked configuration;

FIG. 28 is the section of FIG. 26 but showing the ring binder mechanism in an open configuration.

Corresponding reference characters indicate corresponding parts throughout the drawings.

### DETAILED DESCRIPTION OF THE DRAWINGS

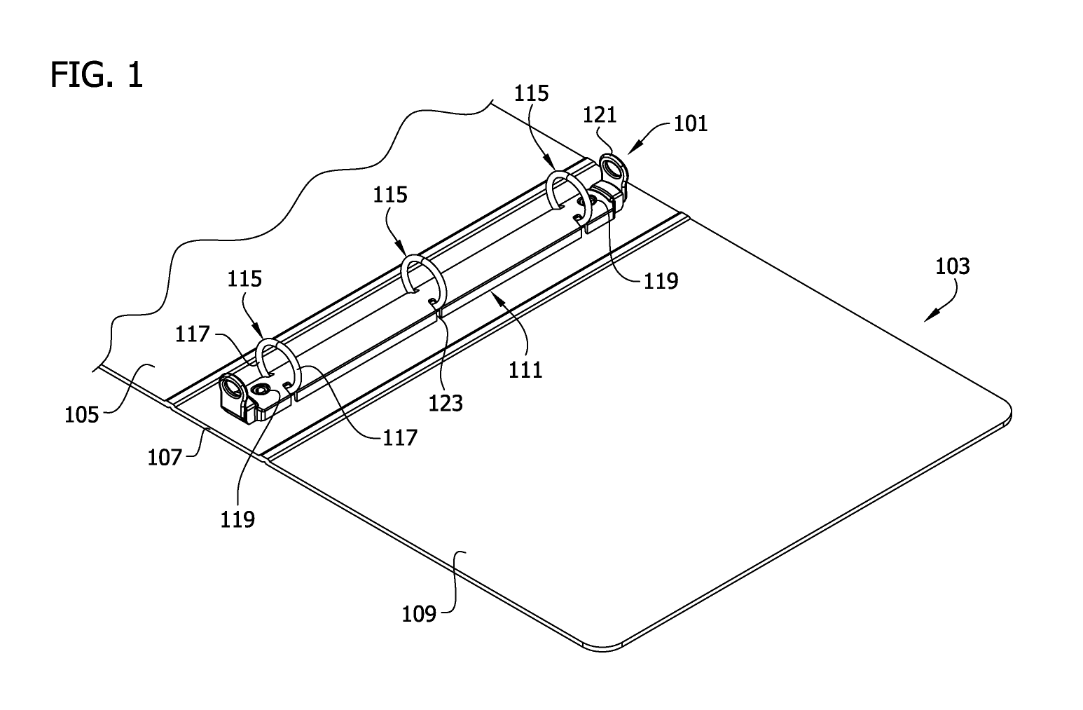

Referring now to the drawings and in particular to FIG. 1, one embodiment of a ring binder mechanism, generally indicated at 101, is mounted on a notebook, which is designated generally at 103. The notebook 103 has a front cover 105, a spine 107, and a back cover 109. The front and back covers 105, 109 of the notebook 103 are hingedly connected to the spine 107 and are selectively moveable to cover or expose loose-leaf pages (not shown) retained by the ring binder mechanism 101. In the illustrated embodiment, the ring binder mechanism 101 is shown mounted on the spine 107 of the notebook 103. It is contemplated, however, that the ring binder mechanism 101 can be mounted on other parts of the notebook 103 (e.g., on the back cover 109), using different types of fasteners (e.g., prong fasteners, screws), or on surfaces other than a notebook (e.g., a file) without departing from the scope of this invention. It is also contemplated that the ring binder mechanism 101 can be unmounted and be within the scope of the invention. The notebook 103 may have other configurations within the scope of the present invention.

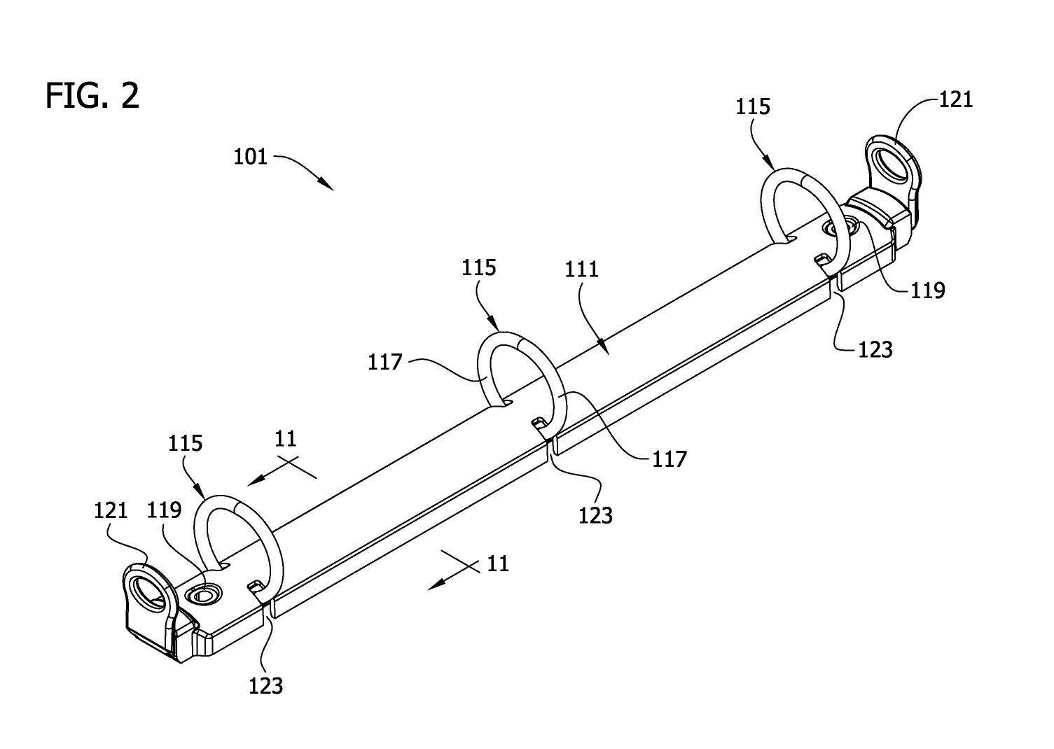

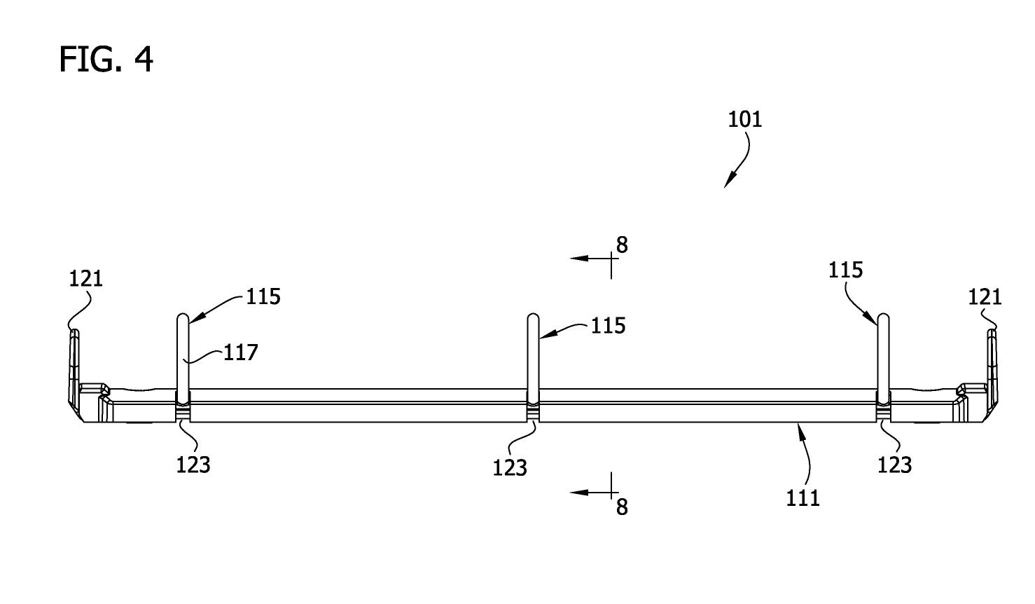

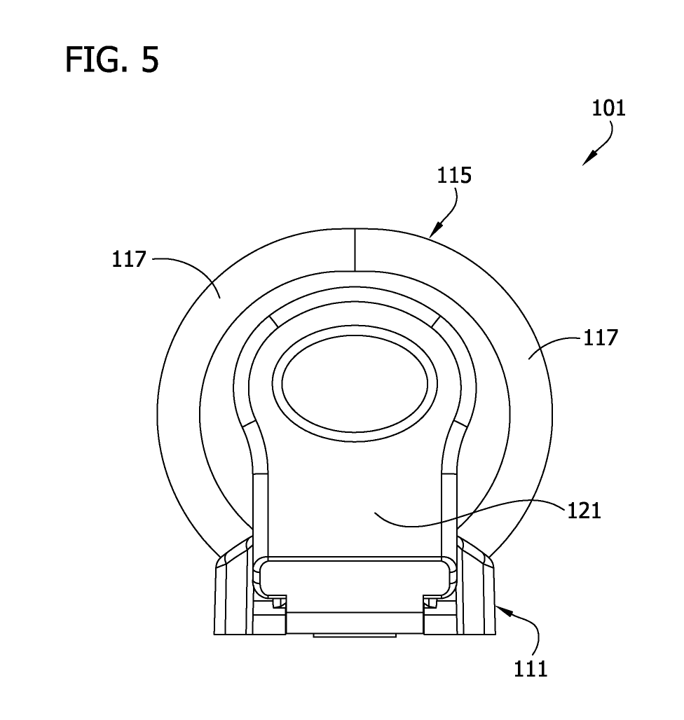

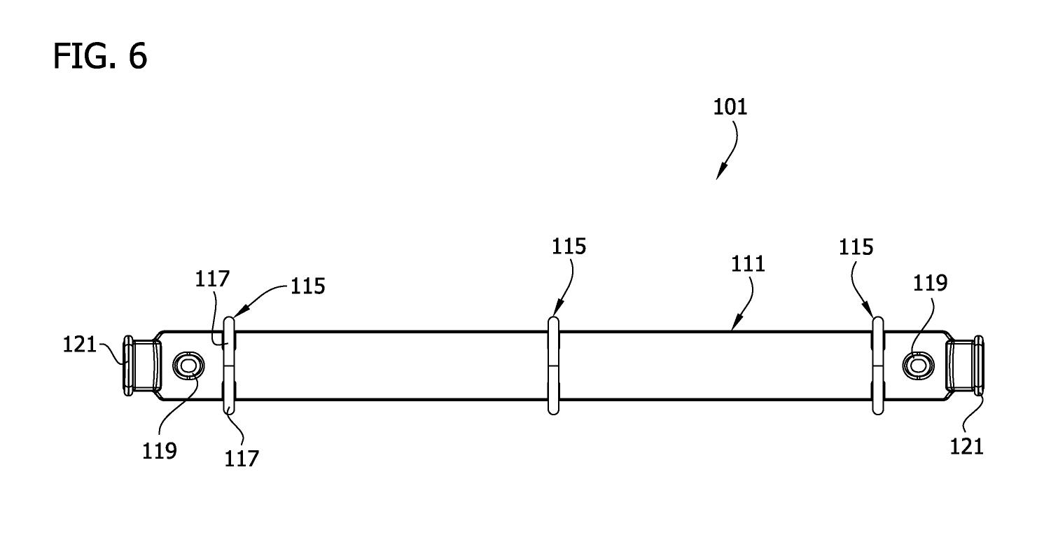

With reference to FIGS. 2-7, the ring binder mechanism 101 has a housing, indicated generally at 111, a pair of hinge plates 113 disposed with the housing, and three rings, each of which is designated generally at 115. Each ring comprises two ring members 117 mounted on respective hinge plates 113. The housing 111 is elongate and comprises a central portion and lateral sides extending downward in generally vertical planes along either side of the central portion between opposite longitudinal ends. The arrangement of the central portion and lateral sides results in the housing having a generally arch-shaped (e.g., U-shaped or C-shaped) cross-section between the longitudinal ends.

The housing 111 includes two mounting posts 119 for mounting the ring binder mechanism 101 on the notebook 103. Each of the mounting posts 119 is tubular having a generally cylindrical wall and a passage therein for allowing a fastener, such as a rivet, to pass through the housing 111. In the illustrated embodiment, one of the mounting posts 119 is positioned generally adjacent one of the longitudinal ends of the housing 111 and the other mounting post is positioned generally adjacent the other longitudinal end. It is understood that the housing 111 can have more than two mounting posts 119 or only a single mounting post.

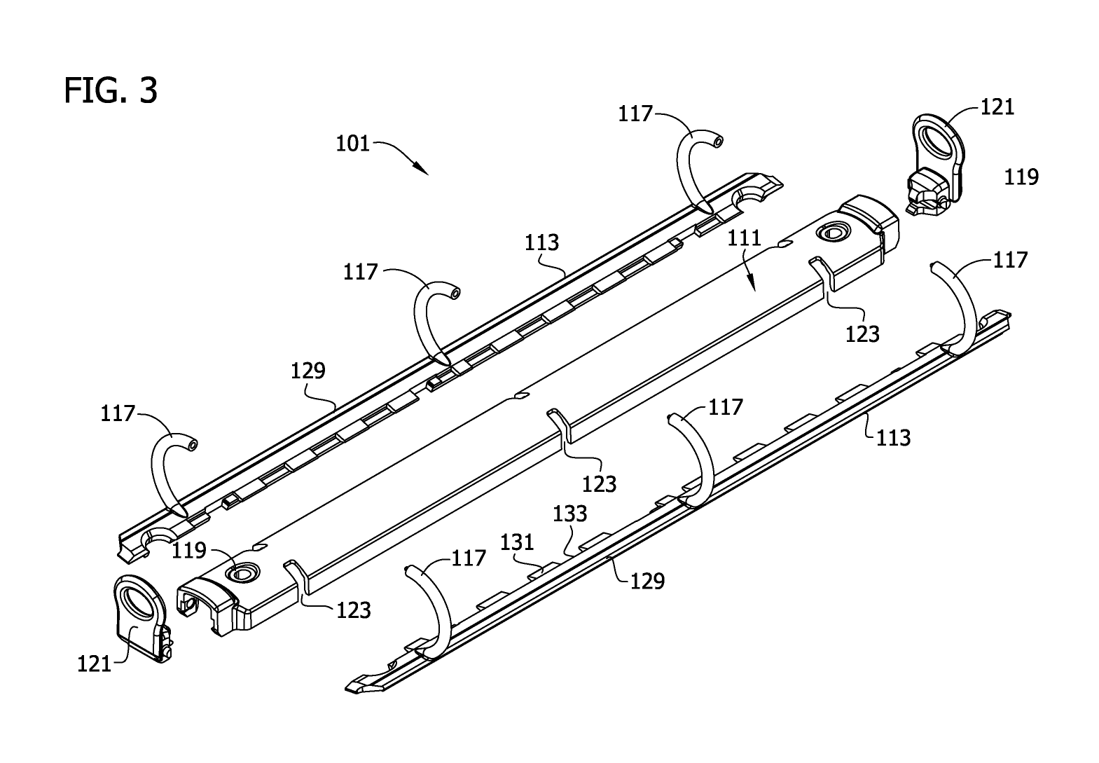

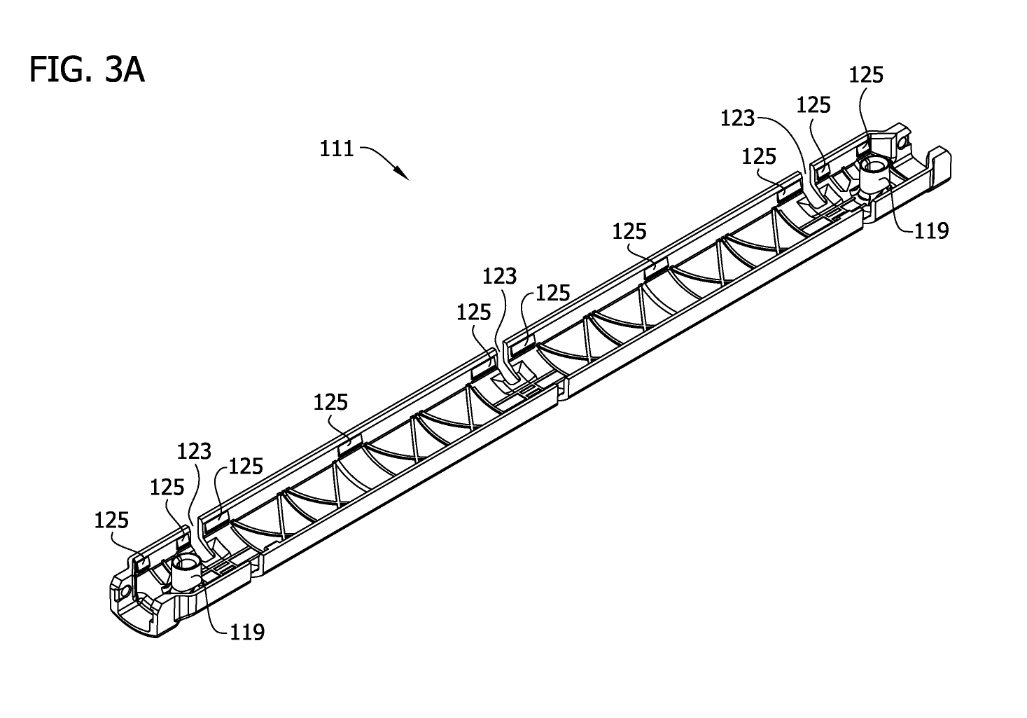

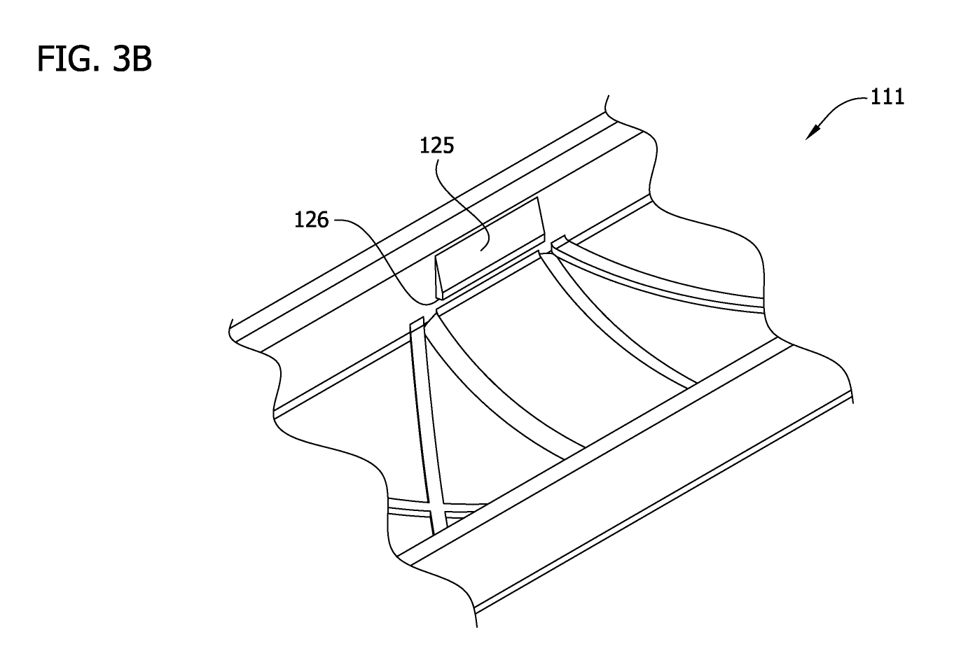

Referring now to FIG. 3, the housing 111 also preferably includes a mount at each of its longitudinal ends mounting a respective actuator 121. In the illustrated embodiment, the actuators 121 can be used to open and close the rings 115. The actuators 121 are formed to receiving portions of the hinge plates 113 for pivoting them to open and close the rings 115. The housing 111 further includes a plurality of slots 123 spaced along the length of the housing for allowing the ring members 117 to pass through the housing. In the illustrated embodiment, the housing 111 includes six slots 123 with three of the slots located along one of its lateral sides and three located along the opposite lateral side. It is understood the housing 111 could have more or fewer slots 123 depending on the number of rings 115.

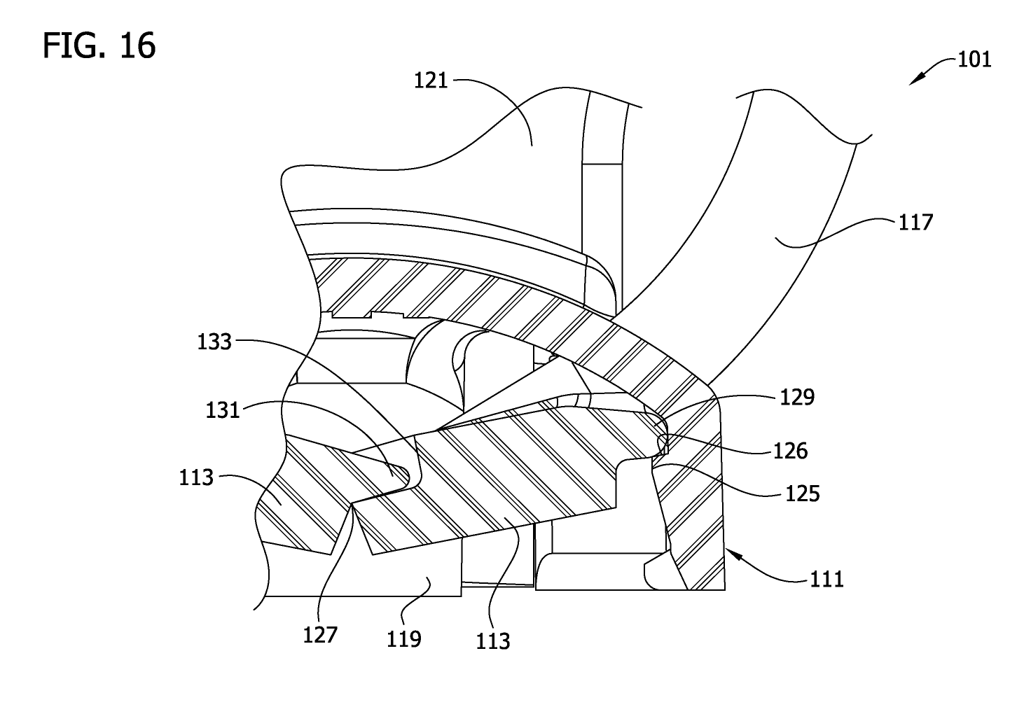

Referring to FIGS. 3A, 3B, and 16, the housing 111 has a plurality of spaced apart hinge plate supports 125 on the inner surfaces of each of its lateral sides for securing the hinge plates 113 within the housing. Each of the hinge plate supports 125 is generally a wedge-shaped tab that includes a sloped wall and a shoulder 126 for engaging and supporting one of the hinge plates 113. It is contemplated, however, that the hinge plates 113 could be held in place via some configuration other than having hinge plate supports 125 (e.g., a channel in the housing with a shoulder for receiving the hinge plates).

The housing 111 is preferably designed to resiliently deform such that the spacing between the lateral sides increases when the hinge plates 113 pass through a coplanar position, which applies an outwardly directed force to the lateral sides of the housing. In the preferred embodiment, the housing 111 is constructed of a resilient polymeric material. Because the housing 111 is preferably constructed of a polymeric material, it can be readily fabricated in a variety of different colors, which is useful for color-coding notebooks. Additionally, text (either raised or imprinted) may be molded into or otherwise formed on the housing 111. Further, the polymeric material does not require nickel plating (as is usually the case with metal housings for ring binder mechanisms) and is therefore agreeable to people who are sensitive to nickel. In the preferred embodiment, the elongate housing 111, first and second hinge plates 113, and ring members 117 are wholly constructed of a resilient polymeric material. For example, the polymeric material can suitably comprise ABS (acrylontrile butadiene styrene). As another example, the polymeric material can suitably be a fiber-reinforced polymeric material. For example, the polymeric material can suitably comprise a mixture of ABS and from about 10 to about 30 percent fiberglass in which case the fiberglass increases strength of the polymeric material.

In the illustrated embodiment, the entire housing 111 is molded as one-piece. However, the housing 111 can be manufactured in different ways, including by being constructed in multiple pieces that are later joined together to make the housing, without departing from the scope of the invention. The housing 111 can also be made from non-polymeric (e.g., metallic) materials and be within the scope of some aspects of this invention.

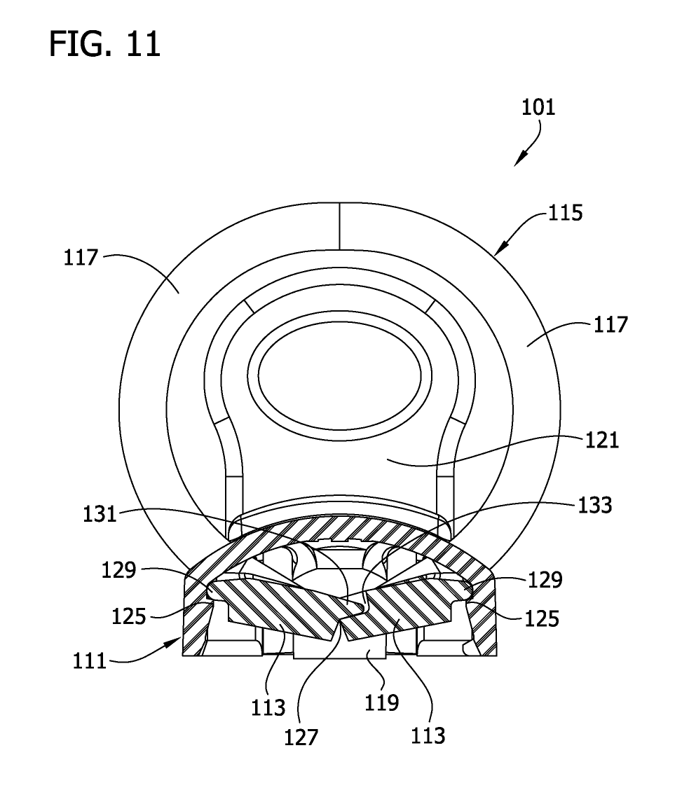

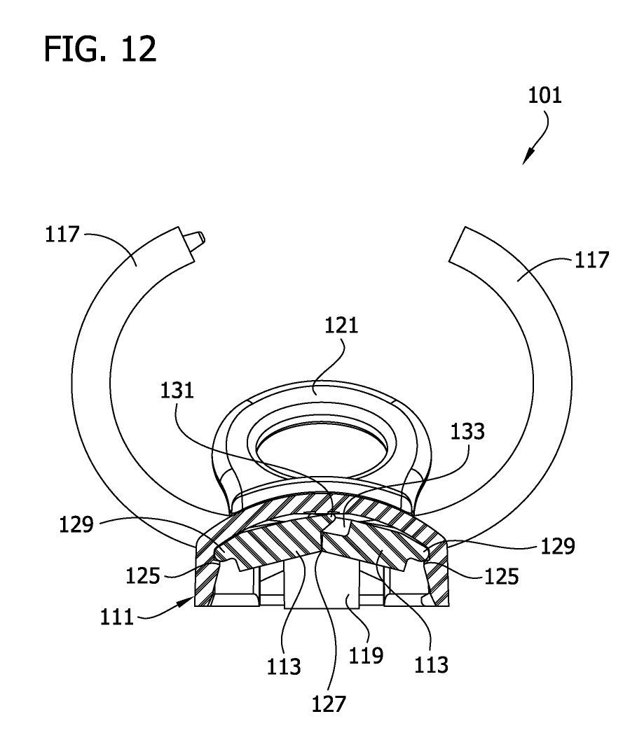

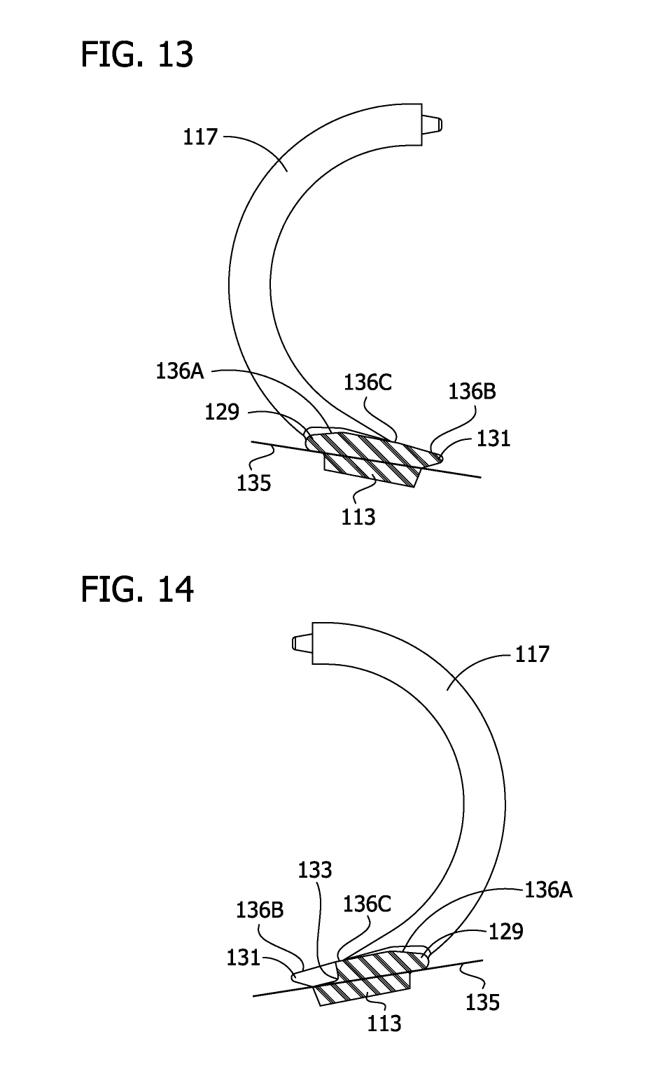

Pivoting movement of the hinge plates 113 in the housing 111 is accompanied by movement of a central hinge 127 upward and downward relative to the housing as well as pivoting movement of outer rounded edge margins 129 of the hinge plates relative to lateral sides of the housing. The hinge plates 113 are interconnected by hinge members 131 and 133. The hinge members 131 and 133 in the illustrated embodiments have an interaction that is illustrated in FIGS. 11 and 12. A first hinge member comprises a finger 131 and a second hinge member comprises a receptacle 133 that receives the finger in at least one, and preferably both, of the open and closed positions of the first and second hinge plates 113. As shown, each hinge plate 113 includes alternating fingers 131 and receptacles 133 along its inner longitudinal edge margin. The fingers 131 and receptacles 133 of the first hinge plate 113 are offset from the fingers and receptacles of the second hinge plate so that the fingers of the first hinge plate are received in the receptacles of the second hinge plate and vice versa. The receptacles 133 open inwardly at the inner longitudinal edges of the hinge plates 113 for receiving the fingers 131 of the opposing hinge plate. The fingers 131 project outwardly from the inner longitudinal edges of the hinge plates 113 to be received by the receptacles 133. The receptacles 133 of each hinge plate 113 preferably extend from the upper surface of the hinge plate into the thickness of the hinge plate toward the mid-plane 135 of the hinge plates (see, FIGS. 13 and 14). The fingers 131 preferably taper in thickness toward the distal end of the finger. The hinge plates 113 preferably have an angular upper surface. The angular upper surface of each hinge plate 113 has a first planar portion 136A adjacent to the outer longitudinal edge margin, a second planar portion 136B adjacent to the inner longitudinal axis, and a third planar portion 136C between the first and second planar portions. The first planar portion 136A and second planar portion 136B lie at angles with respect to the third planar portion 136C (and with respect to each other). The hinge plates 113 could have other shapes (e.g., rounded, rectangular, etc.) and still be within the scope of the invention.

Referring to FIGS. 13 and 14, the fingers and receptacles 131, 133 are disposed at a distance from the mid-plane 135 that is the same as or less than the greatest distance between the upper surface of the hinge plates 113 and the mid-plane. In this case, the third planar portion 136C of the upper surface is farther away from the mid-plane 135 than the finger 131 or receptacle 133. Thus, in a horizontal position of the hinge plates 113, the hinge members 131, 133 are not the highest part of the hinge plates. Reception of the fingers 131 within the receptacles 133 allows pivoting to occur closer to the mid-plane 135 of the hinge plates 113. The highest point of the hinge plates 113 in the open position (FIG. 12) is lower than it would be if the central hinge 127 was at or above the upper surfaces of the hinge plates, as is conventional. This low-profile interaction allows for opening the ring members 117 wider than traditionally available with a housing 111 of the same height.

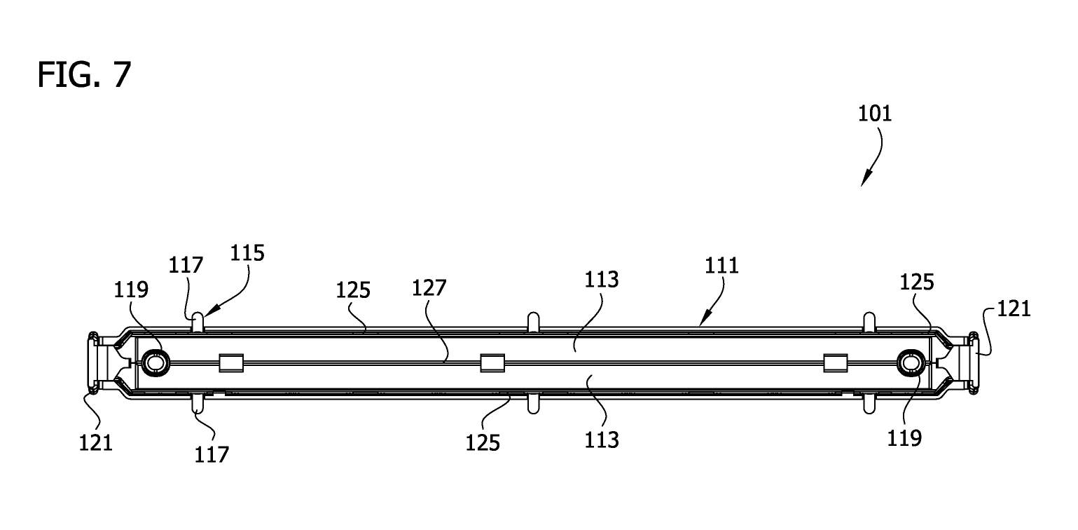

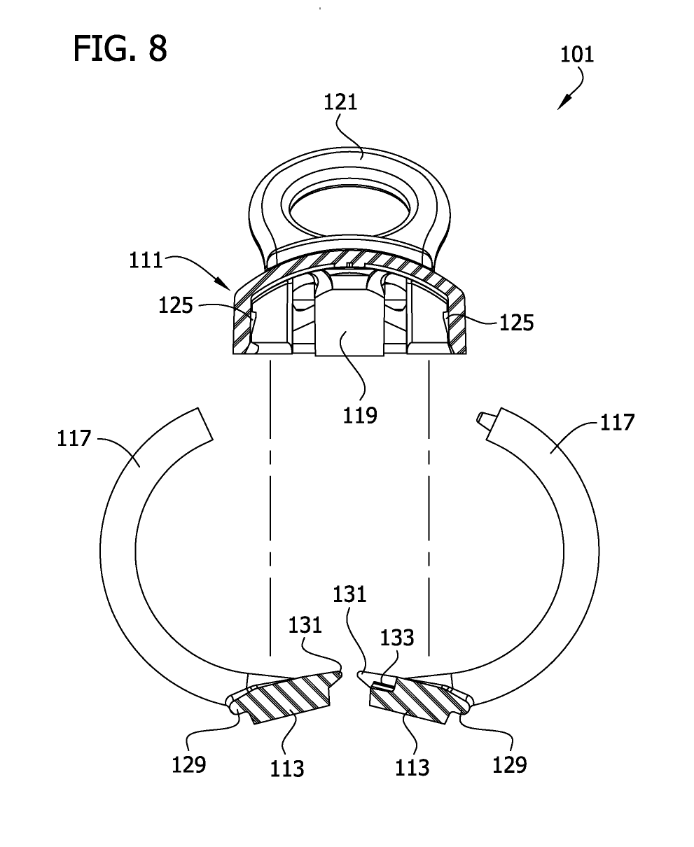

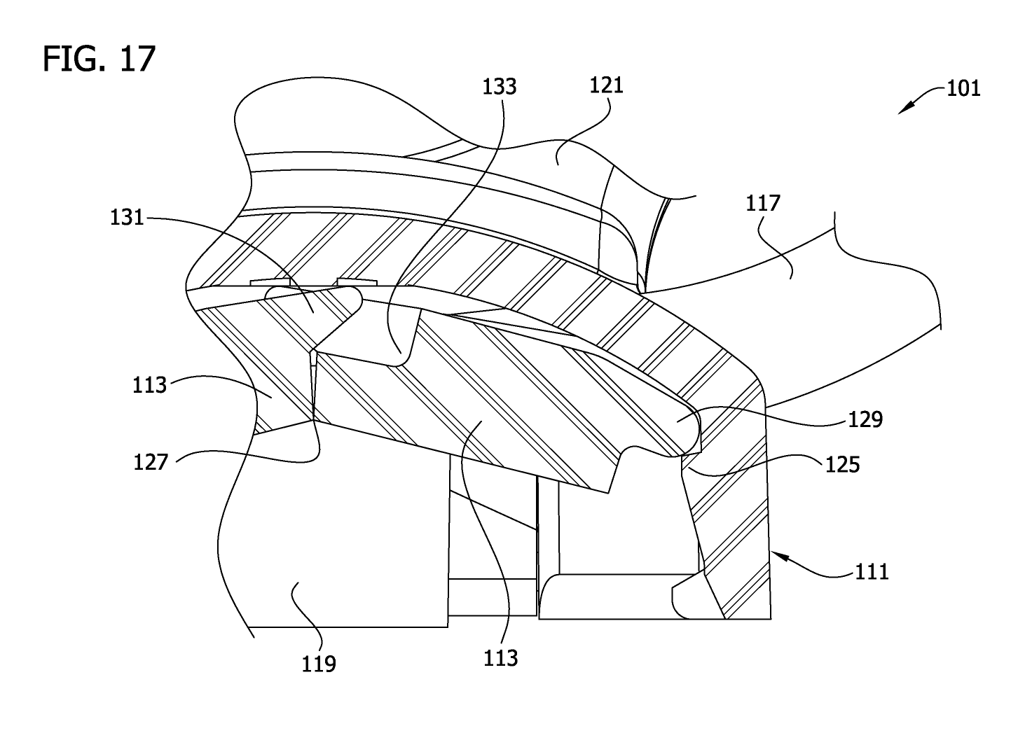

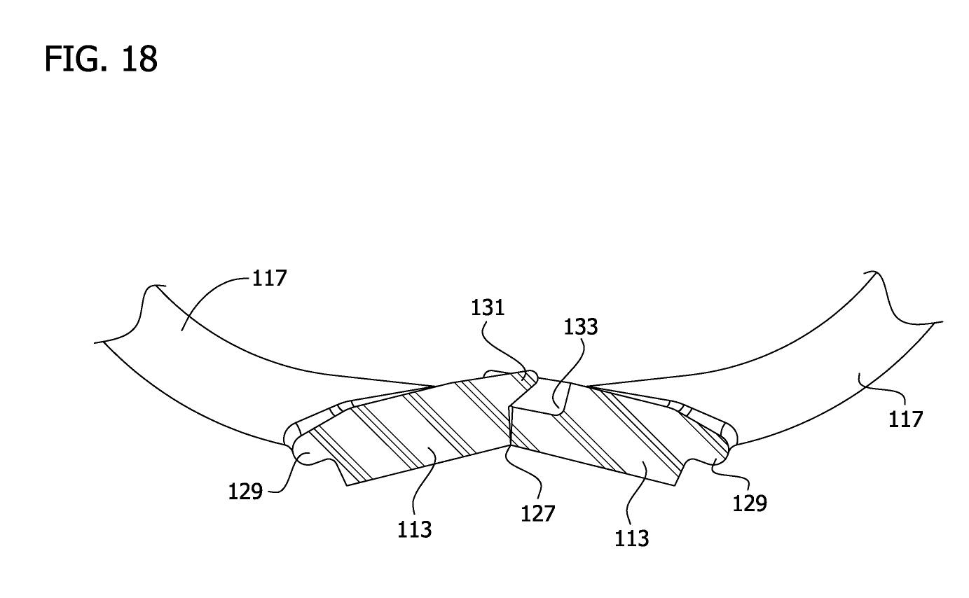

As illustrated in FIG. 3, the hinge plates 113 are each generally elongate, flat, and rectangular in shape, and are shorter in length than the housing 111 so that they fit within the housing. In other words, ends of each of the hinge plates 113 terminate within the housing 111. The hinge plates 113 are interconnected in side-by-side arrangement along their inner longitudinal edge margins forming the central hinge 127 for pivoting movement of the hinge plates relative to one another (FIGS. 7, 11, and 12). The interconnected hinge plates 113 are disposed between the lateral sides of the housing 111 such that outer edge margins of the hinge plates engage the lateral sides above the shoulders of the hinge plate supports 125, which retain the interconnected hinge plates in the housing. Each hinge plate 113 has an outer longitudinal edge that is rounded 129 (see, FIGS. 16 and 17). Each rounded outer longitudinal edge margin 129 has a thickness that is less than the thickness of the hinge plate 113 inward of the rounded outer longitudinal edge margin 129. The radius of curvature of the rounded outer longitudinal edge margin 129 is greater than about 0.4 mm and less than about 1.5 mm. This rounded edge 129 prevents scratching of the housing 111, as well as reducing the resistance force between the hinge plate 113 and the housing during assembly. It will be understood that in some aspects of the present invention, the outer longitudinal edge margins may have different shapes and dimensions.

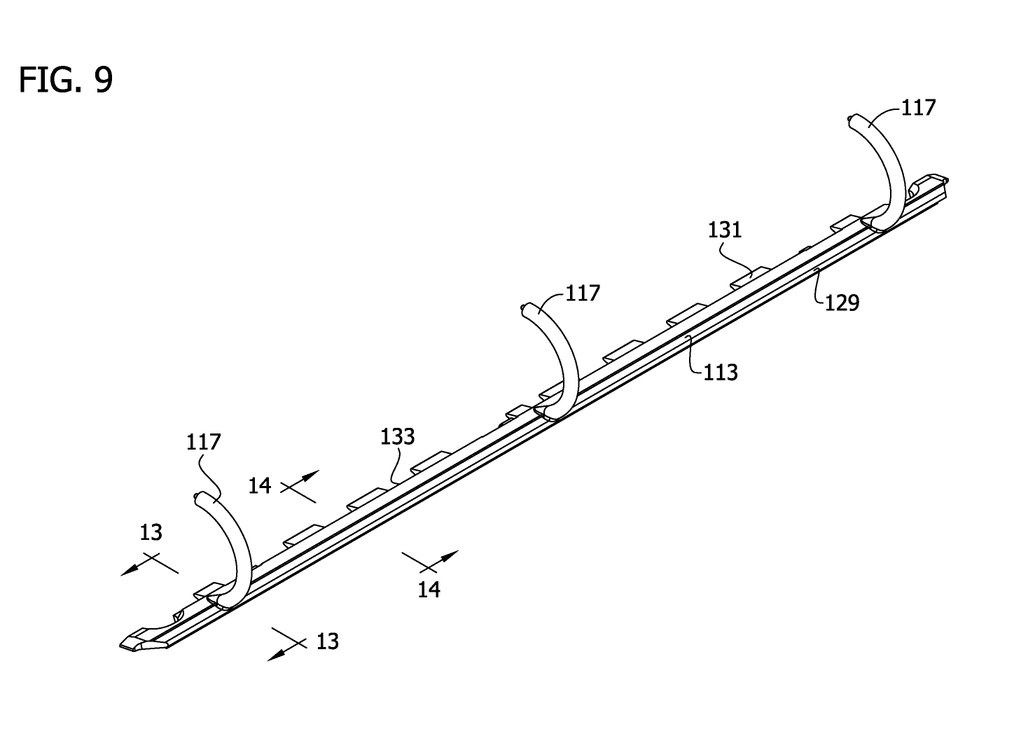

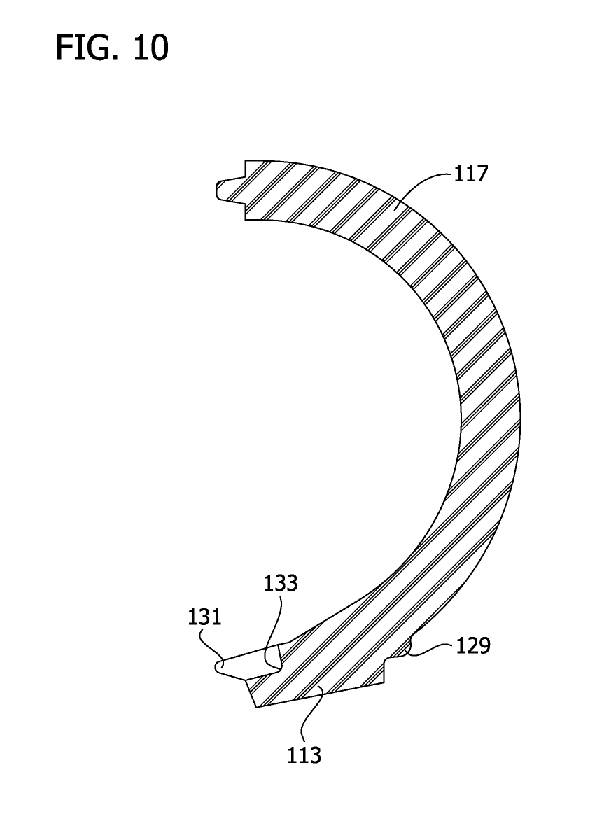

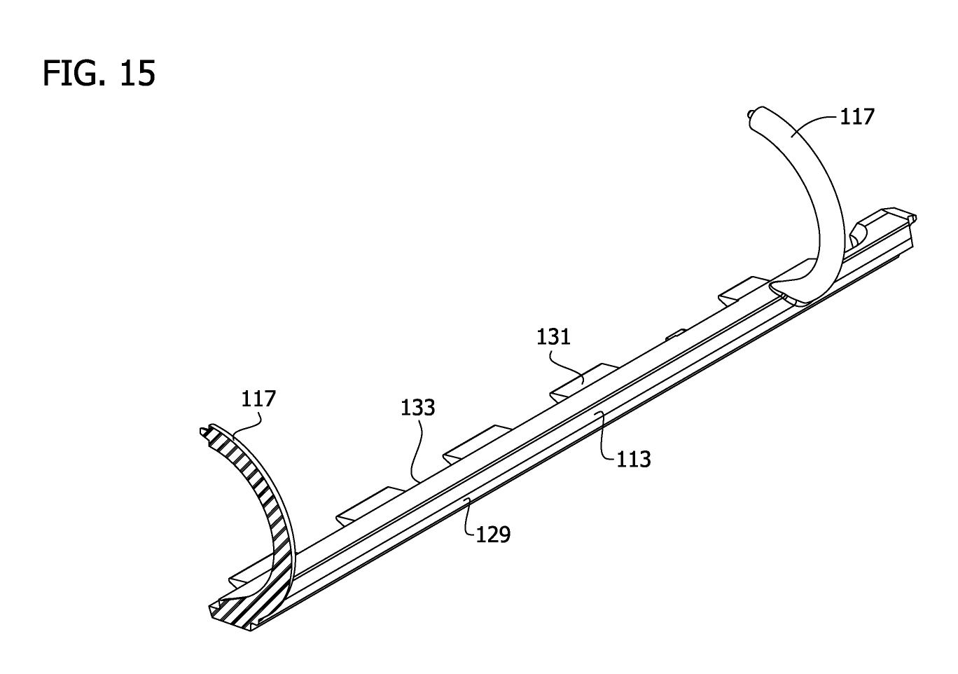

The rings 115 are adapted to retain loose-leaf pages (not shown) on the ring binder mechanism 101. The three rings 115 of the illustrated ring binder mechanism 101 are substantially similar and are each generally circular in shape. As seen in FIG. 2, each ring 115 includes two generally semi-circular ring members 117 formed from a polymeric material and also formed as one piece with the hinge plates 113 and hinge members 131, 133 (FIGS. 9, 10, and 15). However, the ring members 117 could alternatively be attached to the hinge plates 113 in different ways, including by being constructed separately and later joined together with the hinge plates, without departing from the scope of some aspects of the invention. The ring members 117 may also be made of a material other than a polymeric material (e.g., steel). The ring members 117 include free ends that are formed to secure the ring members against misalignment when they are closed together (see, FIGS. 3 and 12). The rings 115 can alternatively be D-shaped as is known in the art, or shaped otherwise within the scope of this invention. Ring binder mechanisms with ring members formed of different material or having different cross-sectional shapes, for example, oval shapes, do not depart from the scope of this invention. Likewise the number of rings supported by the housing can also vary within the scope of the invention.

With reference to FIG. 3, one ring member 117 of each ring 115 is formed as a single piece with the first hinge plate 113, while the other ring member of that ring is formed as a single piece with the second hinge plate. The ring members 117 extend through the slots 123 in the housing 111 and are arranged so their free ends face toward one another above the housing (FIG. 2). The ring members 117 are moveable between an opened position (FIG. 12) in which loose-leaf pages can be added to and/or removed from the ring binder mechanism 101 and a closed position (FIGS. 2, 11) in which the free ends of corresponding ring members are joined to retain any loose-leaf pages on the rings 115 in the ring binder mechanism. In the illustrated ring binder mechanism 101, the ring members 117 of each ring 115 move conjointly with the pivoting movement of the hinge plate 113 on which they are mounted.

The housing 111 is preferably suitably deformed in the opened and closed positions of the rings 115 so that the housing continuously applies a spring force to the hinge plates 113 for holding the rings in either their opened position or their closed position. Other constructions for biasing the hinge plates 113 or otherwise holding the rings 115 in their opened and/or closed positions may be used within the scope of the present invention.

It is understood that the ring binder mechanism 101 can be formed with no actuators or a single actuator 121 instead of the two seen in the accompanying drawings. It is also understood that while two actuators 121 are provided on the illustrated ring binder mechanism 101 only one may be needed to move the hinge plates 113 between their downward and upward positions. That is, the rings 115 can be moved between the opened and closed positions using either one of the two actuators 121. It is further understood that the rings 115 can be moved between their opened and closed position by manually pulling the ring members 117 apart or pushing the rings together whether the ring binder mechanism 101 has zero, one, or two actuators 121.

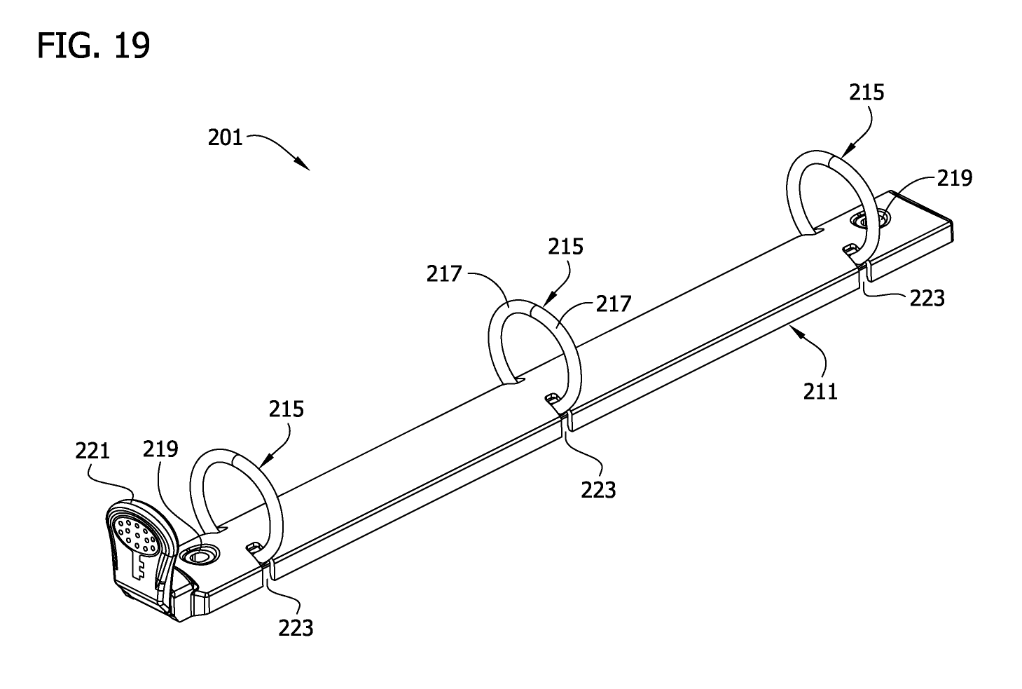

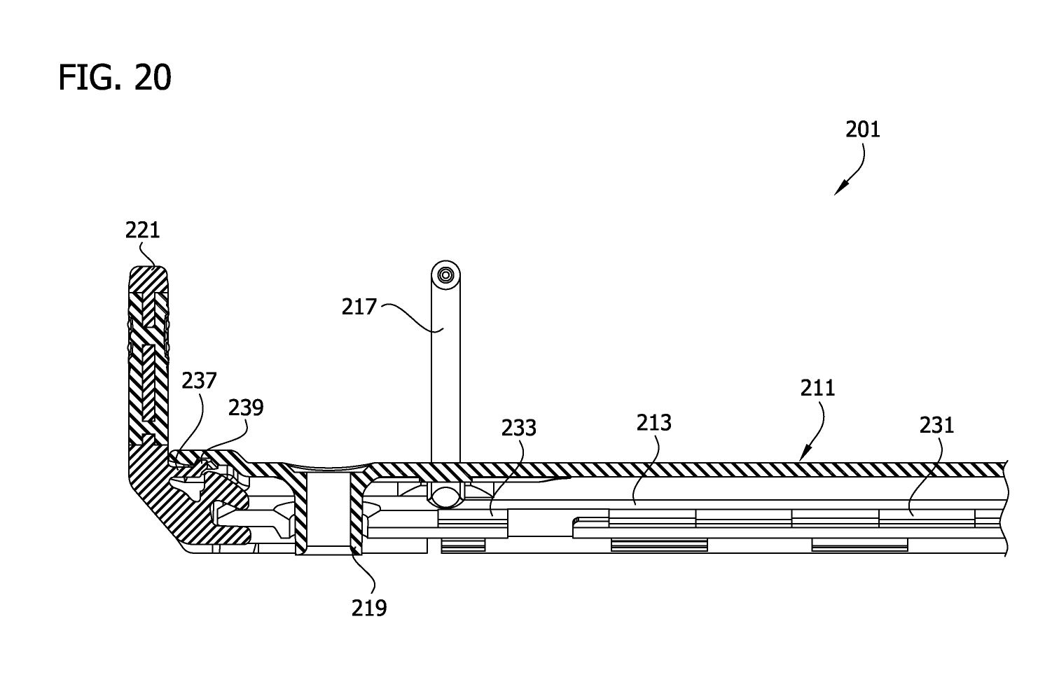

A second embodiment is illustrated generally at 201 in FIGS. 19 and 20. Corresponding elements to the first embodiment are denoted by numbers 100 higher than the elements of the first embodiment to which they correspond. The construction of housing 211, hinge plates 213, and ring members 217 may be the same as described previously herein for the first embodiment. The second embodiment comprises a single actuator 221 and has a locking mechanism associated with the actuator. As shown in FIG. 20, the locking mechanism comprises a resilient arm 237 projecting from the actuator 221. An upstanding detent 239 on the free end of the arm 237 is received in a latching opening formed on the interior of the housing 211 in the closed position and retains the actuator 221 to avoid accidental opening of the rings 215 if the notebook is dropped or otherwise jarred. Application of force to the actuator 221 to pivot to the open position causes the arm 237 to bend downward, releasing the detent 239 from the latching opening thereby unlocking the actuator and allowing the rings 215 to move to the open position. The detent 239 snaps back into the latching opening when the actuator 221 pivots back to the closed position.

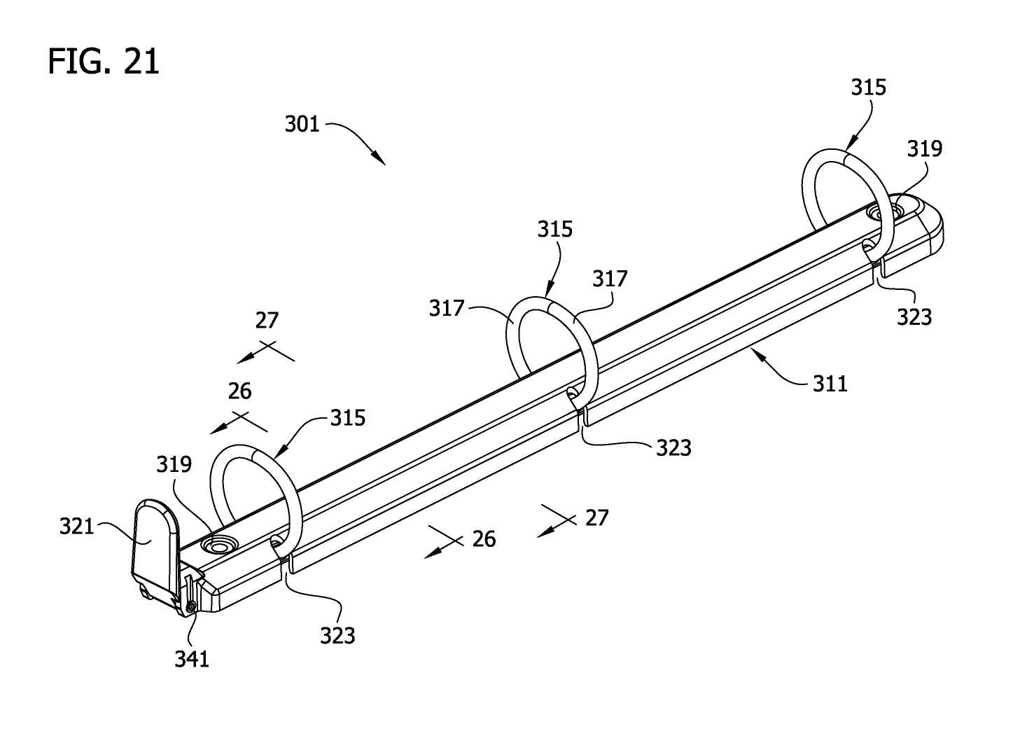

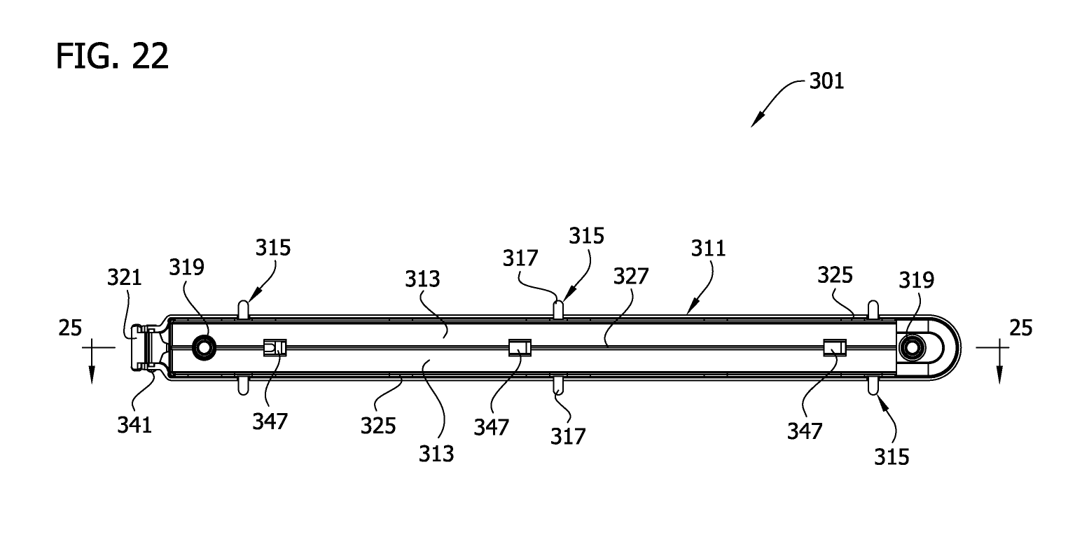

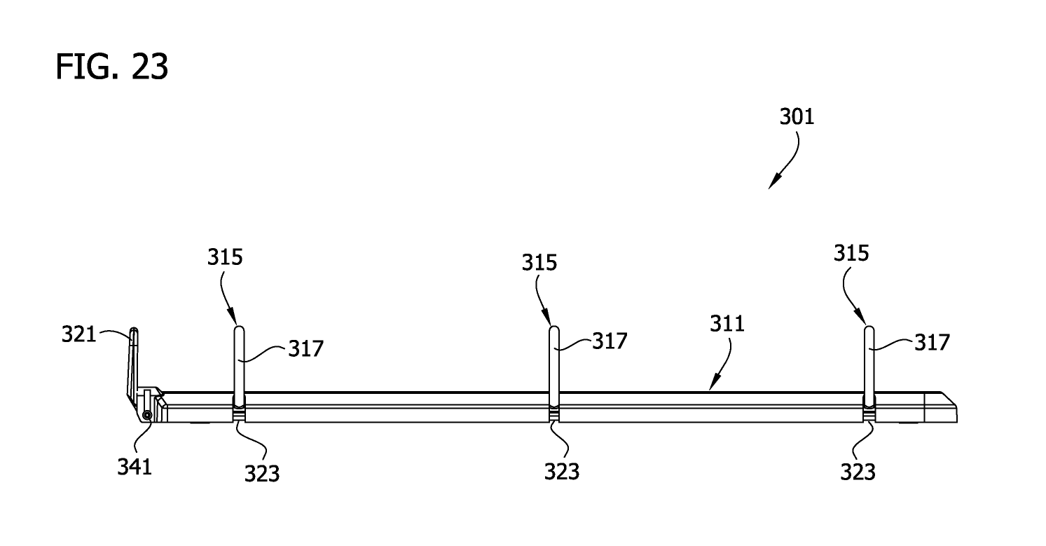

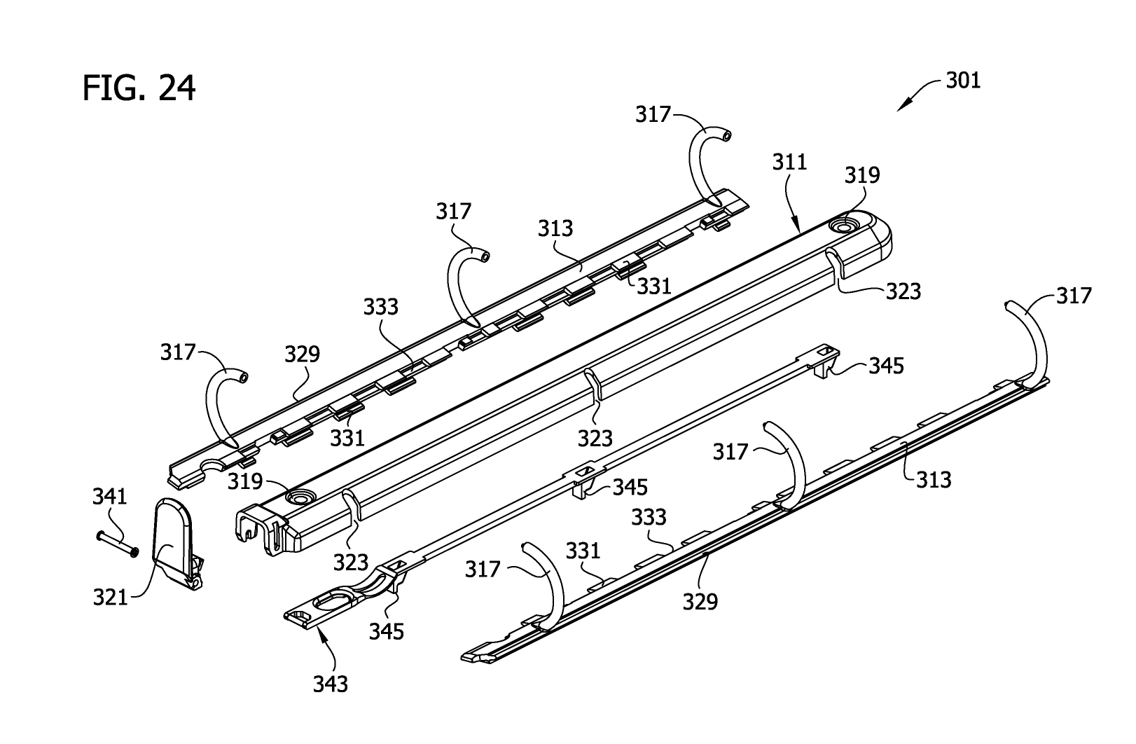

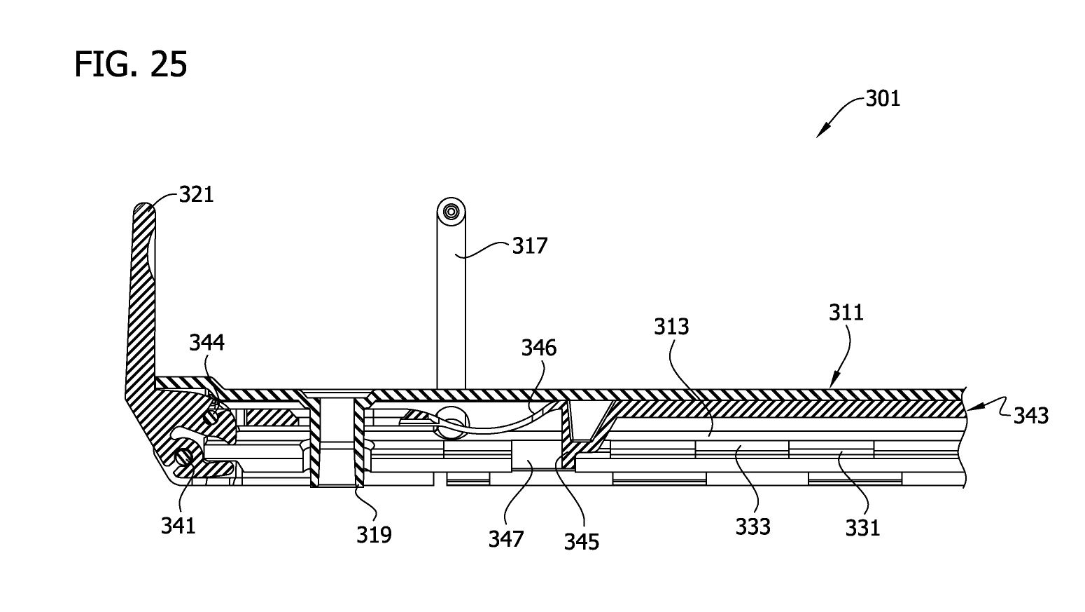

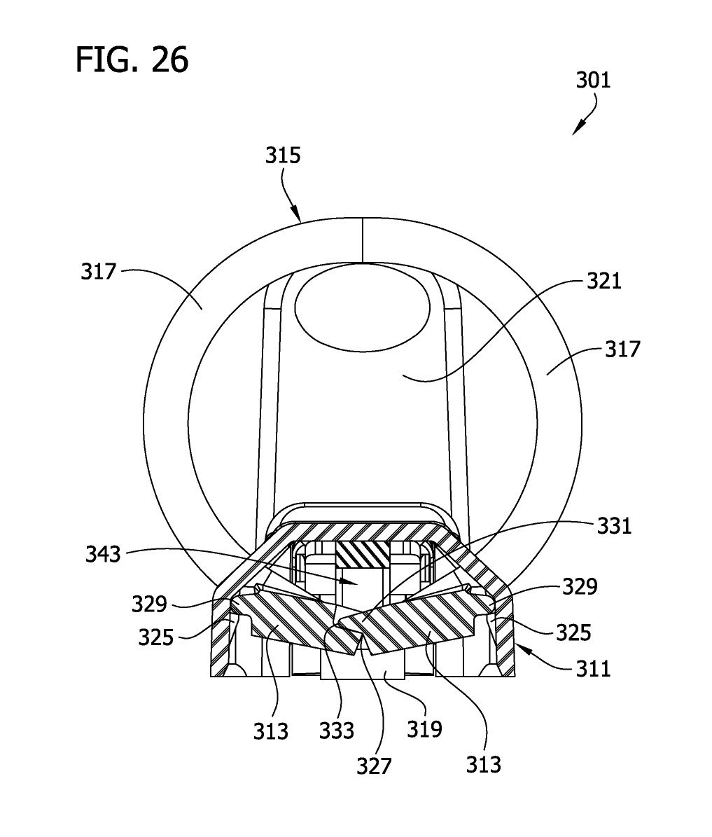

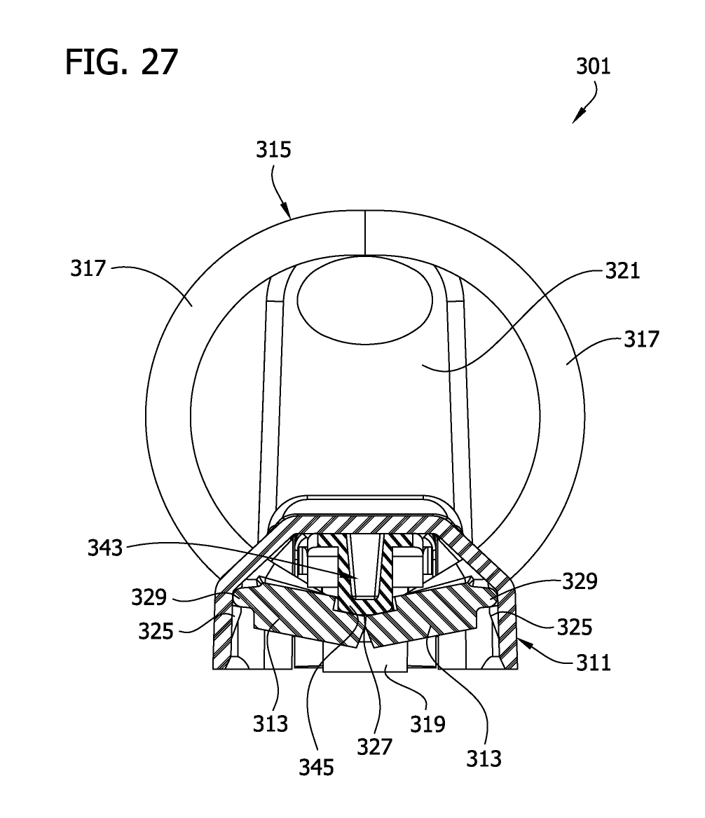

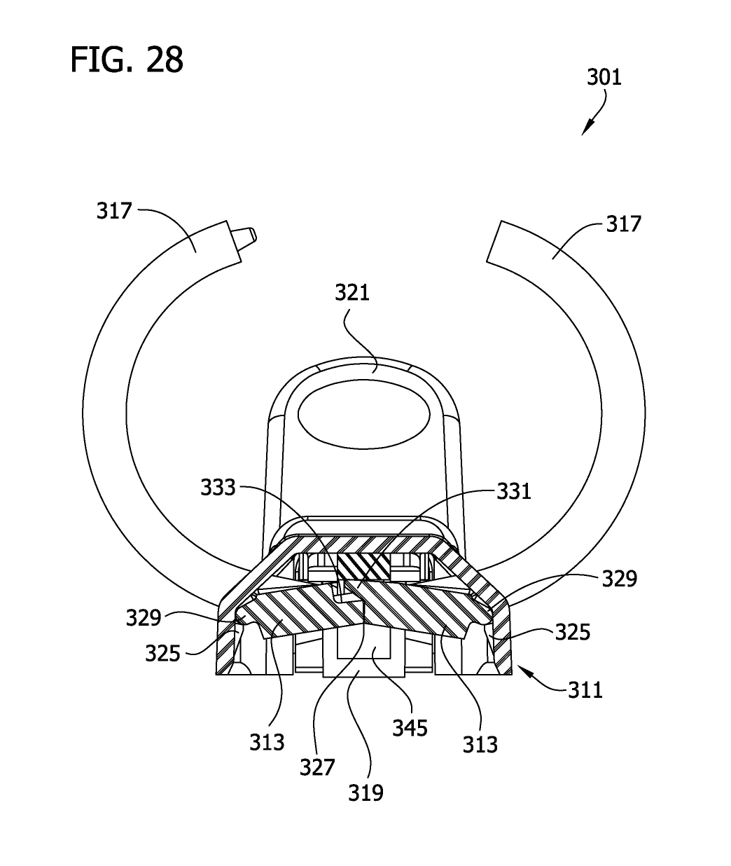

A third embodiment is illustrated generally at 301 in FIGS. 21-28. Corresponding elements to the first embodiment are denoted by numbers 200 higher than the elements of the first embodiment to which they correspond. The construction of housing 311, hinge plates 313, and ring members 317 may be the same as described previously herein for the first embodiment. The third embodiment preferably comprises a single actuator 321. The actuator 321 is connected to the housing 311 via a pin 341. As shown in FIGS. 24 and 25, the third preferred embodiment preferably has a travel bar 343 for locking the ring binder mechanism 301 in the closed position. The travel bar 343 includes an elongate bar having three blocking members 345. The travel bar 343 is connected to the actuator 321 by way of an integrally formed rod 344 of the travel bar so that pivoting of the actuator moves the travel bar lengthwise of the housing 311. A flexible portion 346 of the travel bar 343 allows for lost motion between the movement of the actuator 321 and the travel bar. In the locked position, the blocking members 345 are disposed over the hinge plates 313, blocking the hinge plates from pivoting to the open position (FIG. 27). When moved toward the open position, the blocking members 345 are aligned with holes 347 in the hinge plates 313 that allow the hinge plates to pivot upward to the open position. The housing 311 of the third preferred embodiment preferably has an angular shape as opposed to a C-shape or U-shape.

When introducing elements of the present invention or the preferred embodiments(s) thereof, the articles “a,” “an,” “the,” and “said” are intended to mean that there are one or more of the elements. The terms “comprising,” “including,” and “having” are intended to be inclusive and mean that there may be additional elements other than the listed elements.

As various changes could be made in the above constructions, products, and methods without departing from the scope of the invention, it is intended that all matter contained in the above description and shown in the accompanying drawings shall be interpreted as illustrative and not in a limiting sense.

What is claimed is:

1. A ring binder mechanism for retaining loose-leaf pages, the mechanism comprising:
an elongate housing;
a first hinge plate and a second hinge plate, the hinge plates being supported by the housing for pivoting motion relative to the housing, the first and second hinge plates each having an upper surface, a lower surface and a mid-plane between the upper and lower surfaces;
at least one ring for holding the loose-leaf pages, each ring including a first ring member and a second ring member, the first ring member being mounted on the first hinge plate and moveable with the first hinge plate relative to the housing between a closed position and an open position, in the closed position the first and second ring members cooperatively forming a substantially continuous, closed loop for allowing loose-leaf pages retained by the ring to be moved along the ring from one ring member to the other, and in the open position the first and second ring members form a discontinuous, open loop for adding or removing loose-leaf pages from the ring;
the first hinge plate including a first hinge member and the second hinge plate including a second hinge member engaged with the first hinge member of the first hinge plate, the first and second hinge members each having a maximum spacing from the mid-plane that is the same as or less than the greatest distance between the upper surface and the mid-plane away from the first or second hinge member.

2. The ring binder mechanism as set forth in claim 1 wherein the second hinge member comprises a receptacle formed in the second hinge plate and receiving the first hinge member in at least one of the open and closed positions of the first and second hinge plates.

3. The ring binder mechanism as set forth in claim 2 wherein the second hinge plate has a thickness, the receptacle extending from the upper surface of the second hinge plate into the thickness of the second hinge plate toward the mid-plane of the second hinge plate.

4. The ring binder mechanism as set forth in claim 3 wherein the second hinge plate includes an inner longitudinal edge, the receptacle opening inwardly at the inner longitudinal edge of the second hinge plate for receiving the first hinge member of the first hinge plate.

5. The ring binder mechanism as set forth in claim 2, wherein the first hinge plate includes an inner longitudinal edge, the first hinge member comprising a finger projecting inwardly from the inner longitudinal edge, the finger being received in the receptacle in at least one of the open and closed positions of the first and second hinge plates.

6. The ring binder mechanism as set forth in claim 5 wherein the finger tapers in thickness generally from the longitudinal edge of the first hinge plate toward a distal end of the finger.

7. The ring binder mechanism as set forth in claim 1 wherein the first ring member is formed as one piece with the first hinge plate and the second ring member is formed as one piece with the second hinge plate.

8. The ring binder mechanism as set forth in claim 7 wherein the first and second hinge plates are made of polymeric material.

9. The ring binder mechanism as set forth in claim 8 wherein the elongate housing is made of polymeric material.

10. The ring binder mechanism as set forth in claim 1 wherein the first and second hinge plates each comprise an outer longitudinal edge engaging the elongate housing for pivoting on the elongate housing, the outer longitudinal edge being rounded.

11. The ring binder mechanism as set forth in claim 1 wherein the first hinge member comprises a finger and the second hinge member comprises a receptacle receiving the finger.

12. The ring binder mechanism as set forth in claim 11 wherein the first and second hinge plates each include plural fingers and plural receptacles.

13. The ring binder mechanism as set forth in claim 12 wherein the fingers and receptacles on each of the first and second hinge plates alternate along a length of the hinge plate.

14. The ring binder mechanism as set forth in claim 1 wherein at least one of the housing and the hinge plates is made of a polymeric material comprising ABS and fiberglass.

15. The ring binder mechanism as set forth in claim 1 in combination with a cover, the ring binder mechanism being mounted on the cover.

16. A ring binder mechanism for retaining loose-leaf pages, the mechanism comprising:
an elongate housing;
a first hinge plate and a second hinge plate, the hinge plates being supported by the housing for pivoting motion relative to the housing, the hinge plates having an inner longitudinal edge margins hingedly engaged with each other to permit the pivoting motion and an outer longitudinal edge margins engaged with the housing;
at least one ring for holding the loose-leaf pages, each ring including a first ring member and a second ring member, the first ring member being mounted on the first hinge plate and moveable with the first hinge plate relative to the housing between a closed position and an open position, in the closed position the first and second ring members cooperatively forming a substantially continuous, closed loop for allowing loose-leaf pages retained by the ring to be moved along the ring from one ring member to the other, and in the open position the first and second ring members form a discontinuous, open loop for adding or removing loose-leaf pages from the ring;
the outer longitudinal edge margins each being rounded to facilitate the pivoting motion of the first and second hinge plates with respect to the housing.

17. The ring binder mechanism as set forth in claim 16, wherein each rounded outer longitudinal edge margin has a radius of curvature that is greater than about 0.4 mm and less than about 1.5 mm.

18. The ring binder mechanism as set forth in claim 16 wherein the rounded outer longitudinal edge margin of the first hinge plate has a thickness that is less than the thickness of the first hinge plate inward of the rounded outer longitudinal edge margin of the first hinge plate, and the rounded outer longitudinal edge margin of the second hinge plate has a thickness that is less than the thickness of the second hinge plate inward of the rounded outer longitudinal edge margin of the second hinge plate.

19. The ring binder mechanism as set forth in claim 16 wherein the elongate housing is formed with first and second shoulders engaging the outer longitudinal edge margins of the first and second hinge plates, respectively.

20. The ring binder mechanism as set forth in claim 19 wherein the elongate housing further comprises a channel, each channel including the shoulder and receiving a respective one of the outer longitudinal edge margins of the first and second hinge plates.

21. The ring binder mechanism as set forth in claim 16 wherein at least one of the housing and the hinge plates is made of a polymeric material comprising ABS and fiberglass.

22. The ring binder mechanism as set forth in claim 16 in combination with a cover, the ring binder mechanism being mounted on the cover.
